(19) United States
(12) Patent Application Publication
(10) Pub. No.: US 2011/0314988 A1
(43) Pub. Date: Dec. 29, 2011

(54) LOCKING MECHANISM FOR A MITER SAW

(76) Inventors: Kesong Xu, Jiangdong District (CN); Yun Huang, Jiangning District (CN)

(21) Appl. No.: 13/169,625

(22) Filed: Jun. 27, 2011

(30) Foreign Application Priority Data
Jun. 28, 2010 (CN) 201020241095.3

(51) Int. Cl. B23D 45/04; B23D 47/02; B23D 45/14

(52) U.S. Cl. 83/471.3

(57) ABSTRACT

The present invention discloses a miter saw having a base, a worktable rotatably connected to the base, a supporting arm rotatably connected to the worktable about a first axis and a front inclination locking mechanism. The locking mechanism has a first locking member connected to the supporting arm behind the worktable, a second locking member cooperating with the first locking member, a controlling lever optionally connected to the second locking member, and a handle in front of the worktable connected to the controlling lever. The second locking member may rotate in relation to the first locking member about a second axis parallel to the first axis. The locking mechanism may be tightened or loosened from in front of the worktable and without the use of a tool, allowing for easier and more efficient locking of the miter saw.

### CROSS-REFERENCE TO RELATED APPLICATIONS

This application claims priority to CN 201020241095.3, filed Jun. 28, 2010, which is hereby incorporated by reference.

### FEDERALLY SPONSORED RESEARCH OR DEVELOPMENT

Not Applicable.

### TECHNICAL FIELD

The present invention relates to an electrical tool, specifically a miter saw, and more particularly to a miter saw with a front inclination locking mechanism.

### BACKGROUND OF THE INVENTION

The front inclination locking mechanism for a miter saw currently available in the market generally takes the form of a cam, a lever or a screw-lock. These types of locks have some inherent defects. After a long period of use, the gap between the contact surfaces could be widened due to the wear of the locking contact surfaces. As a result, the predetermined stroke of the operating handle cannot lock the supporting arm on the worktable. Specifically, with a locking cam or a lever, the locking stroke is constant and cannot be changed. Therefore, it is impossible to achieve a lock once the gap is increased, requiring the user to readjust the gap between the contact surfaces to achieve an effective lock. In the screw-lock situation, a tool is needed to tighten the screw and requires the locking to occur behind the machine. The location of the lock and the requirement of a tool results in this type of locking mechanism being very inconvenient.

Also, in order to utilize a cam or locking mechanism as the locking mechanism, the manufacturing can be complicated and result in additional manufacturing costs. Finally, a common screw-locking mechanism may have a small thread pitch making it impossible to lock the supporting arm with a small rotating angle of the operating handle which results in lengthening the operating time if the rotating angle needs to be increased.

### SUMMARY OF THE INVENTION

The technical problem to be solved by the present invention is to provide a miter saw with a front inclination locking mechanism which may be simply operated, adjusted easily and has a low cost.

In order to solve the above technical problems of prior solutions, the present invention provides a miter saw comprising a base, a worktable rotatably connected to the base, a supporting arm rotatably connected to the worktable about an axis and a front inclination locking mechanism. The front inclination locking mechanism has a first locking member connected to the supporting arm and located at the rear portion of the worktable, a second locking member cooperating with the first locking member, a controlling lever optionally connected to the second locking member and a handle in front of the worktable connected to the controlling lever. The second locking member may be rotatable with regard to the first locking member about another axis parallel to the first axis.

In the aforesaid miter saw, the controlling lever is rotatable about the axis X′ and movable between a first position in which the controlling lever is connected with the second locking member and a second position in which the controlling lever is disconnected from the second locking member in the direction of the axis X′. A restoring spring may be arranged between the controlling lever and the worktable.

Also, the miter saw of the present invention may lock or loosen the worktable and the supporting arm to each other through access in front of the worktable. During the operation of the locking adjustment, the operator can work in front of the machine without any other tools, and it is unnecessary to go to the back of the machine. This construction has a low manufacturing cost, and the user may adjust the angle position of the locking handle according to his preferences so as to fit to operational habits of the user.

### BRIEF DESCRIPTION OF THE DRAWINGS

To understand the present invention, it will now be described by way of example, with reference to the accompanying drawings in which:

FIG. 1 is a schematic view showing the structure of a miter saw according to a first embodiment of the present invention;

FIG. 2 is an exploded view of a front inclination locking mechanism of the miter saw of FIG. 1;

FIG. 3 is a schematic view showing a normal working state of the front inclination locking mechanism of the miter saw of FIG. 1;

FIG. 4 is a schematic view showing the position adjustment of the handle of the front inclination locking mechanism of the miter saw of FIG. 1;

FIG. 5 is an enlarged view of section A in FIG. 4; and,

FIG. 6 is a perspective view of the handle of the front inclination locking mechanism of the miter saw of FIG. 1.

### DETAILED DESCRIPTION

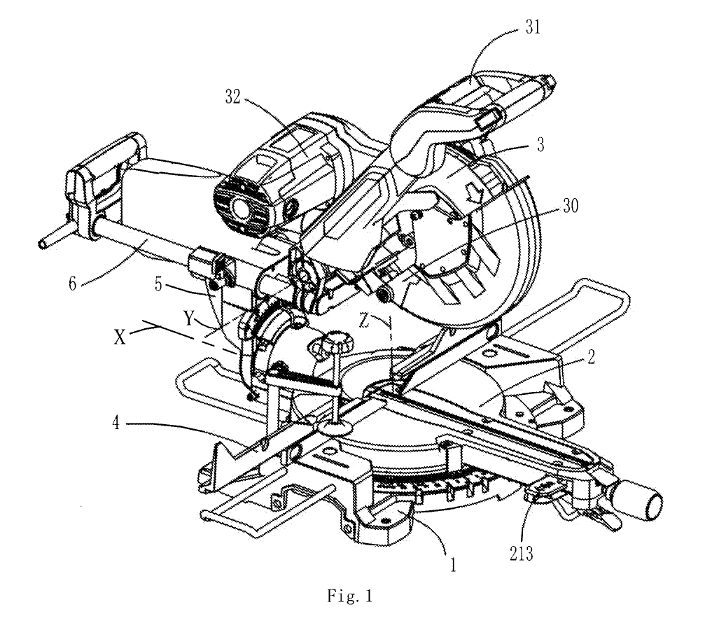

The present invention will be further explained with reference to the drawings. Referring to FIG. 1, a miter saw 10 comprises a base 1, a worktable 2 rotatably connected to the base 1, a supporting arm 5 rotatably connected to the worktable 2 about an axis X, a sliding bar mechanism 6 slidably connected to the supporting arm 5, a saw device 3 pivotally connected to the sliding bar mechanism 6 about an axis Y, and a fence 4 connected to the base 1. In other embodiments of the miter saw, the sliding bar mechanism may be omitted, and the saw device may be pivotally connected to the supporting arm directly. The saw device 3 includes a saw blade 30, a motor 32 for supplying power to the saw blade and a handle 31. The work piece to be machined (not shown) may be disposed on the worktable 2 and abut against the fence 4. The miter saw 10 may perform an angle cut by rotating the worktable 2 which supports the saw device 3 about an axis Z with regard to the base. It may perform a bevel cut by rotating the supporting arm 5 about the axis X with regard to the worktable 2. The axis X, axis Y and axis Z are mutually vertical to each other.

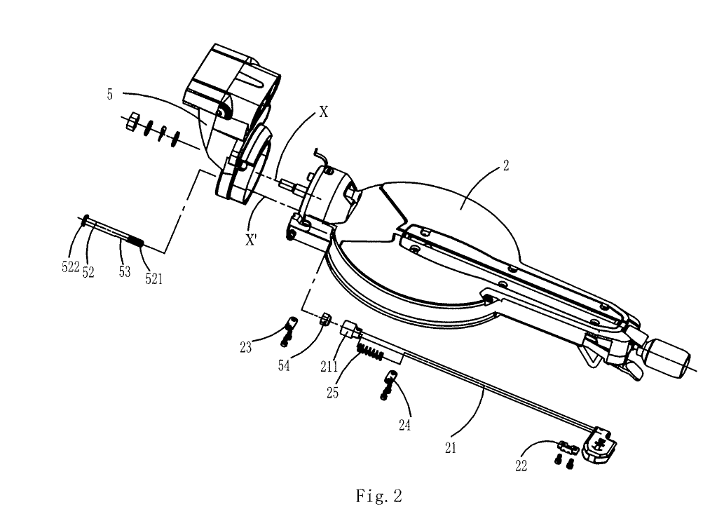

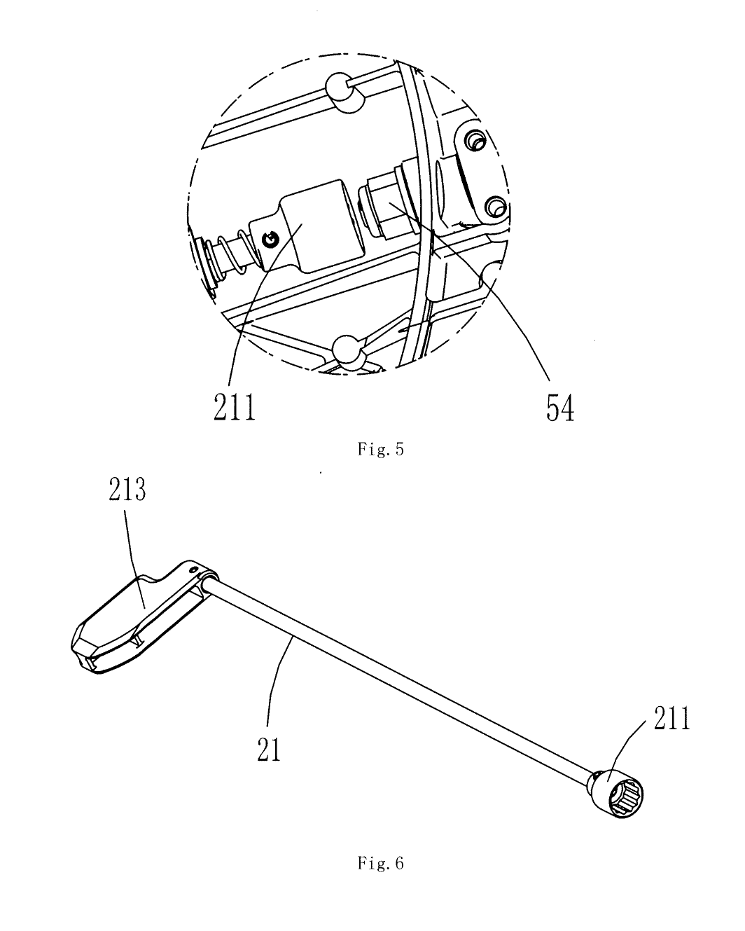

Next, the inclination locking mechanism will be explained in further detail with reference to FIGS. 1-6. The inclination locking mechanism includes a first locking member 52, a second locking member 54 and a controlling lever 21. The first locking member 52 passes through an arc-shaped hole (not shown) in the supporting arm 5 and a hole (not shown) in the back portion of the worktable 2 along the axis X′. One end 521 of the first locking member 52 cooperates with the second locking member 54, and the other end, as a dead end 522, bears against one side of the supporting arm 5 which is positioned away from the worktable. The second locking member 54 may be rotated about the axis X′ with regard to the first locking member 52. The axis X′ is parallel to the axis X. Preferably, the end 521 of the first locking member 52 is provided with outer threads, and the second locking member 54 is a hexagonal nut and is provided with inner threads which may be engaged with the end 521. By rotating the second locking member 54 about the axis X′, the second locking member is movable along the direction of the axis X′ on the first locking member 52, and by adjusting the distance between the dead end 522 of the first locking member and the second locking member 54, the supporting arm 5 may be locked or loosened with regard to the worktable 2. The thread of the first and second locking members may be preferably double threaded so as to achieve a faster tightening or locking and loosening. A pressure plate 23 is fixed to the bottom of the worktable to provide pressure to a flat portion 53 of the first locking member 52 so as to prevent the first locking member 52 from rotating about the axis X′ with the second locking member 54.

The controlling lever 21 is mounted to the bottom of the worktable by a pressure plate 24, and may be rotated about the axis X′. One end of the controlling lever 21 is provided with a controlling member 211 for controlling the rotation of the second locking member 54. The controlling member 211 is preferably an inner dodecagon spanner which may be mounted on the second locking member 54 so that the second locking member 54 can be rotated about the axis X′. The other end of the controlling lever 21 is located in front of the worktable 2 and provided with a handle 213 extending laterally along the axis X′ so as to facilitate the operator to operate the controlling lever. A restoring spring 25 is arranged between the controlling lever 21 and the bottom of the worktable. Preferably, the restoring spring 25 is mounted onto the controlling lever 21, and the two ends of the restoring spring 25 abut against the controlling member 211 and a member at the bottom of the worktable respectively, and exert a force on the controlling lever 21 to enable it to trend to move towards the second locking member 54.

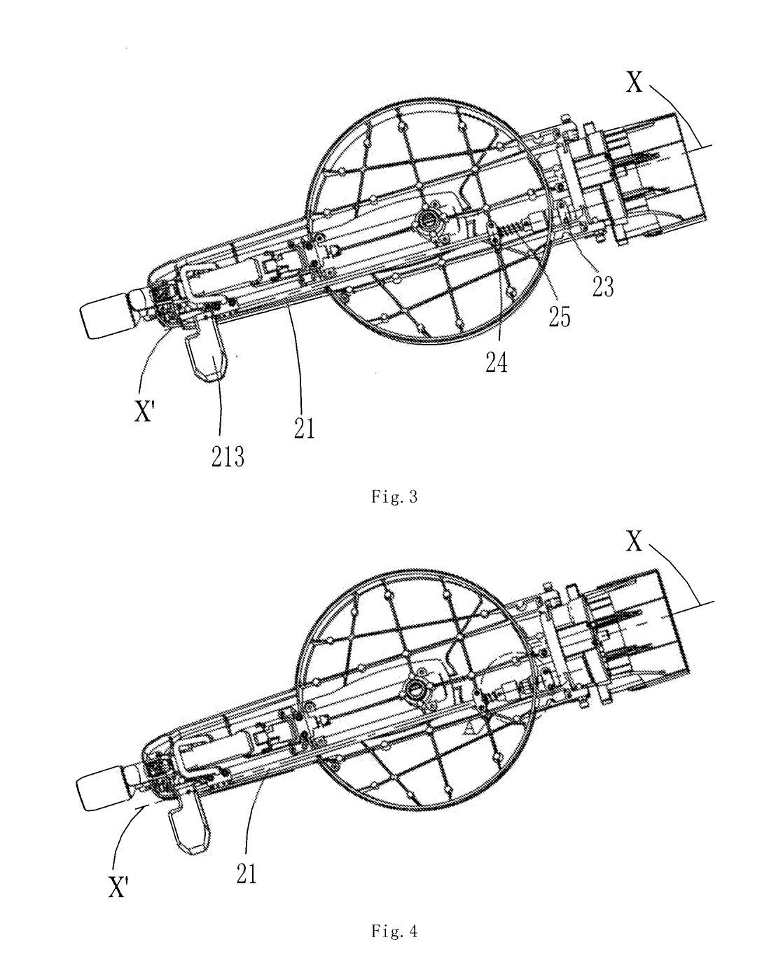

The controlling lever 21 may be pulled to move between a first position and a second position by the handle 213. As shown in FIG. 3, in the first position, under the spring force action of the restoring force 25, the controlling member 211 is engaged with the second locking member 54. The operator may operate the controlling lever 21 to rotate about the axis X′ by the handle 213 so as to make the second locking member 54 rotate with regard to the first locking member 52. As a result, the supporting arm 5 may be locked or loosened with regard to the worktable. As shown in FIG. 4, when the operator pulls the controlling lever 21 through the handle to make it move to the second position along the axis X′ by overcoming the spring force action of the restoring spring 25, the controlling member 211 is disengaged from the second locking member 54. The operator may then operate the controlling lever 21 to rotate about the axis X′ by the handle 21 so as to adjust the angle of the handle 213 about the axis X′ and the operator may easily adjust the handle 213 to an angle to allow for easier operation. Another advantage of the controlling lever 21 being disengaged from the second locking member 54 is that when the distance between the dead end 522 of the first locking member 52 and the second locking member 54 is increased such that a lock cannot be achieved by using the handle to rotate the controlling lever in the position as shown in FIG. 3, the controlling lever may be moved to the second position to disengage the controlling member from the second locking member. This allows for the handle to cause the controlling lever to rotate the controlling member in a loosening direction and makes the controlling lever return to the first position so that the controlling member is engaged with the second locking member. The controlling lever is further rotated towards the locking direction so as to achieve a lock and allow for the user to easily adjust the locking mechanism in the front of the miter saw.

The controlling lever may also be a flexible lever, as long as the controlling member at one end is rotatable about the axis X′. The flexible lever may transmit rotational movement, and may also transmit linear movement. As a benefit, it can change the position and the angle of the handle while not being limited to the locking position. It can also be easier to arrange and more suitable for operation.

The above description discloses embodiments of the present invention, which are not used to limit the present invention. Any technical solutions obtained by equivalent replacements or changes will be regarded as part of the scope of this invention.

What is claimed is:

1. A miter saw, comprising:
a base;
a worktable rotatably connected to the base;
a supporting arm rotatably connected to the worktable about an axis X; and,
a front inclination locking mechanism;
wherein the front inclination locking mechanism comprises
a first locking member connected to the supporting arm and located at the rear of the worktable;
a second locking member in cooperation with the first locking member;
a controlling lever coupled to the second locking member;
a handle in front of the worktable, connected to the controlling lever;
the second locking member further being rotatable with regard to the first locking member about an axis X′ parallel to the axis X.

2. The miter saw according to claim 1, wherein the controlling lever is rotatable about the axis X′ and movable between a first position where the controlling lever is connected with the second locking member and a second position where the controlling lever is disconnected from the second locking member in the direction of the axis X′.

3. The miter saw according to claim 2, wherein the controlling lever is provided with a controlling member at a first end distal a front portion of the worktable, and the controlling member is engaged with the second locking member in the first position and disengaged from the second locking member in the second position.

4. The miter saw according to claim 1, wherein a restoring spring is arranged between the controlling lever and the worktable.

5. The miter saw according to claim 1, wherein the handle extends laterally along the axis X′.

6. The miter saw according to claim 1, wherein the first locking member passes through a hole in the supporting arm and a hole in a rear portion of the worktable along the axis X′, and one end of the first locking member is in cooperation with the second locking member and the other end thereof is a dead end bearing against the supporting arm.

7. The miter saw according to claim 1, wherein a first end of the first locking member is provided with outer threads, and the second locking member is a hexagonal nut with inner threads engaged with the first end of the first locking member.

8. The miter saw according to claim 7, wherein the second locking member is movable along the direction of the axis X′ on the first locking member through its rotation about the axis X′, and the supporting arm is tightened or loosened with regard to the worktable by adjusting the distance between a second end of the first locking member and the second locking member.

9. The miter saw according to claim 7, wherein the outer threads of the first end of the first locking member and the inner threads of the hexagonal nut of the second locking member are double threads.

10. The miter saw according to claim 1, wherein the controlling member is an inner dodecagon spanner.

11. A miter saw, comprising:
a base;
a worktable rotatably connected to the base;
a supporting arm rotatably connected to the worktable about an axis X; and,
a front inclination locking mechanism;
wherein the front inclination locking mechanism comprises
a first locking member connected to the supporting arm and located at the rear of the worktable;
a second locking member in cooperation with the first locking member;
a controlling lever coupled to the second locking member;
a restoring spring arranged between the controlling lever and the worktable;
a handle in front of the worktable, connected to the controlling lever, wherein the handle extends laterally along an axis X′;
the second locking member further being rotatable with regard to the first locking member about the axis X′ parallel to the axis X.

12. The miter saw according to claim 11, wherein the controlling lever is rotatable about the axis X′ and movable between a first position where the controlling lever is connected with the second locking member and a second position where the controlling lever is disconnected from the second locking member in the direction of the axis X′.

13. The miter saw according to claim 12, wherein the controlling lever is provided with a controlling member at a first end distal a front portion of the worktable, and the controlling member is engaged with the second locking member in the first position and disengaged from the second locking member in the second position.

14. The miter saw according to claim 11, wherein a first end of the first locking member is provided with outer threads, and the second locking member is a hexagonal nut with inner threads engaged with the first end of the first locking member.

15. The miter saw according to claim 14, wherein the second locking member is movable along the direction of the axis X′ on the first locking member through its rotation about the axis X′, and the supporting arm is tightened or loosened with regard to the worktable by adjusting the distance between a second end of the first locking member and the second locking member.

16. The miter saw according to claim 14, wherein the outer threads of the first end of the first locking member and the inner threads of the hexagonal nut of the second locking member are double threads.

17. The miter saw according to claim 11, wherein the controlling member is an inner dodecagon spanner.
